(19) United States
(12) Patent Application Publication
(10) Pub. No.: US 2025/0310451 A1
(43) Pub. Date: Oct. 2, 2025

(54) INSPECTION APPARATUS AND METHOD FOR CONTROLLING THE SAME

(71) Applicant: CANON KABUSHIKI KAISHA, Tokyo (JP)

(72) Inventor: KENICHIROU HARUTA, Chiba (JP)

(21) Appl. No.: 19/084,223

(22) Filed: Mar. 19, 2025

(30) Foreign Application Priority Data
Apr. 1, 2024 (JP) 2024-059139

(51) Int. Cl. H04N 1/00

(52) U.S. Cl. CPC H04N 1/0044; H04N 1/00087; H04N 1/00477

(57) ABSTRACT

An inspection apparatus comprises an inspection unit configured to inspect a scanned image in which a scanning unit scans a sheet on which an image is formed, the sheet being conveyed from an image processing apparatus; and a control unit configured to perform control to cause image forming of a second and subsequent sheets to stand by until image forming of a first sheet and inspection according to inspection settings are completed in a job of performing image forming on a plurality of sheets.

### BACKGROUND OF THE INVENTION

### Field of the Invention

The present invention relates to an inspection apparatus and a method for controlling the same.

### Description of the Related Art

In recent years, there is a known printing system that enables an inspection apparatus to inspect, during conveyance, a sheet printed by a printing apparatus (hereinafter, called a print sheet). In inspection of the print sheet, the inspection apparatus scans an image of the print sheet that is conveyed, and determines whether or not printing of the print sheet is normal by image analysis of the scanned image. The inspection for detecting an abnormality of the print sheet is called print image inspection. The inspection apparatus can detect, for example, a missing of a barcode or a ruled line, a missing image, a print error, a missing page, a color shift, and the like. When it is determined that the print sheet is an abnormal sheet in this manner, the abnormal sheet can be discharged to a sheet discharge destination different from that of a normal sheet. This prevents the abnormal sheet from being mixed into the normal sheet, and the operator can discard the abnormal sheet.

In some cases, an image is printed on a pre-printed sheet on which a form format such as an invoice is printed in advance (hereinafter, an image printed in advance is called a pre-printed image), and image inspection may be performed. For example, in the case of an invoice, for printing of an image on a common pre-printed sheet, it is necessary to individually print content that is different one by one depending on the content of the invoice.

Japanese Patent Laid-Open No. 2007-310567 proposes an inspection apparatus that generates mask data based on parts individually printed on a pre-printed sheet, sets a peripheral area of the parts individually printed to be an inspection area, collates images of the parts individually printed, and, if the images are identical, determines to be normal.

If the pre-printed sheet is set in the printing apparatus in an incorrect orientation up and down or front and back, printing is performed at an incorrect position in the form format. At this time, the inspection apparatus determines an “error” in the inspection of the first sheet. Sheets residual in the machine subsequent to the error sheet of the first sheet (hereinafter, called “in-machine residual sheet”) are errors without exception, and all the residual sheets in the machine are wasted.

The proposed inspection apparatus can cope with a case where printing is performed in an inclined manner, but does not cope with detection of an error in setting of the pre-printed sheet because an individual printed part is determined to be normal when the pre-printed sheet is set in an incorrect orientation. Since the in-machine residual sheet is taken into no consideration, there is a problem that all the in-machine residual sheets are wasted.

The present invention enables realization of an inspection apparatus that reduces waste paper.

### SUMMARY OF THE INVENTION

One aspect of the present invention provides an inspection apparatus comprising: an inspection unit configured to inspect a scanned image in which a scanning unit scans a sheet on which an image is formed, the sheet being conveyed from an image processing apparatus; and a control unit configured to perform control to cause image forming of a second and subsequent sheets to stand by until image forming of a first sheet and inspection according to inspection settings are completed in a job of performing image forming on a plurality of sheets.

Another aspect of the present invention provides a method for controlling an inspection apparatus comprising: inspecting a scanned image in which a scanning unit scans a sheet on which an image is formed, the sheet being conveyed from an image processing apparatus; and performing control to cause image forming of a second and subsequent sheets to stand by until image forming of a first sheet and inspection according to inspection settings are completed in a job of performing image forming on a plurality of sheets.

Further features of the present invention will become apparent from the following description of exemplary embodiments (with reference to the attached drawings).

### BRIEF DESCRIPTION OF THE DRAWINGS

FIG. 1 is a view illustrating an example of an overall configuration of an inspection system of the present invention.

FIG. 2 is an example of an internal configuration diagram of an image forming apparatus 100 according to one embodiment.

FIG. 3 is an example of a hardware configuration diagram of the image forming apparatus 100 according to one embodiment.

FIG. 4 is a block diagram illustrating a functional configuration of the image processing apparatus according to one embodiment.

FIG. 5 is a flowchart showing a processing procedure of inspection processing performed by the image processing apparatus according to one embodiment.

FIG. 6 is a flowchart showing a processing procedure of inspection setting processing performed by the image processing apparatus according to one embodiment.

FIG. 7 is an example of a display screen according to one embodiment.

FIG. 8 is a flowchart showing a processing procedure of inspection execution processing according to one embodiment.

FIG. 9 is an example of a display screen according to one embodiment.

FIGS. 10A and 10B are views for describing an effect according to one embodiment.

FIG. 11 is an example of a result display screen according to one embodiment.

FIG. 12 is a flowchart showing a processing procedure of inspection execution processing according to one embodiment.

FIG. 13 is an example of a display screen according to one embodiment.

FIG. 14 is an example of a display screen according to one embodiment.

FIG. 15 is a flowchart showing a processing procedure of inspection execution processing according to one embodiment.

FIG. 16 is an example of a display screen according to one embodiment.

### DESCRIPTION OF THE EMBODIMENTS

Hereinafter, embodiments will be described in detail with reference to the attached drawings. Note, the following embodiments are not intended to limit the scope of the claimed invention. Multiple features are described in the embodiments, but limitation is not made to an invention that requires all such features, and multiple such features may be combined as appropriate. Furthermore, in the attached drawings, the same reference numerals are given to the same or similar configurations, and redundant description thereof is omitted.

### FIRST EMBODIMENT

### Configuration of Entire System

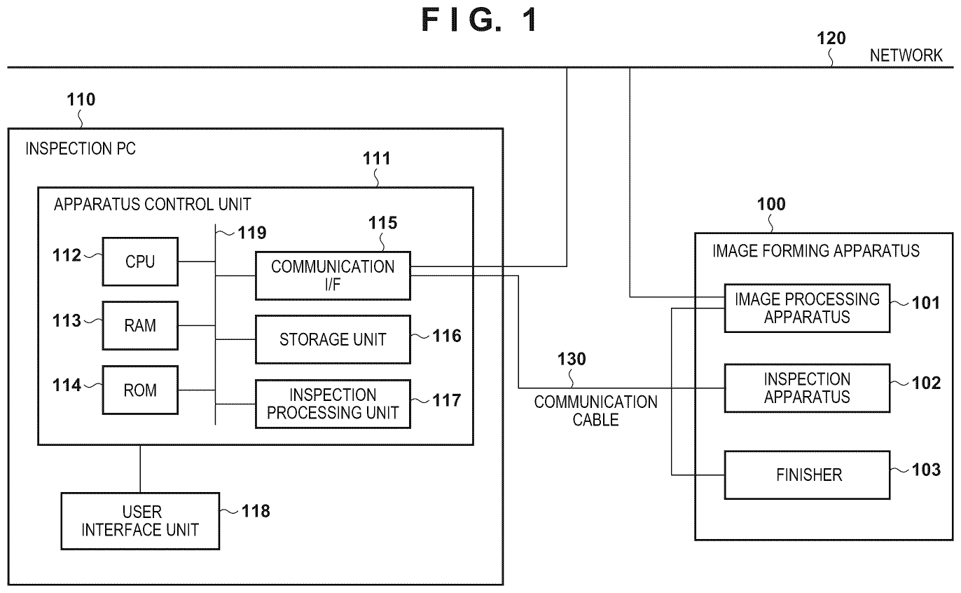

FIG. 1 is an overall configuration diagram of a system including an inspection apparatus for describing the present embodiment. The system including the inspection apparatus in the present embodiment includes the image forming apparatus 100, an inspection PC 110, a network 120, and a communication cable 130.

The image forming apparatus 100 receives various input data and print job data via the network 120 and performs print output. The image forming apparatus 100 includes an image processing apparatus 101, an inspection apparatus 102, and a finisher 103. The image processing apparatus 101, the inspection apparatus 102, the finisher 103, and the inspection PC 110 are connected via the communication cable 130, which is an internal bus.

The image processing apparatus 101 performs image processing according to print settings on various input data, and outputs, as a printed matter, an image subjected to the image processing.

The inspection apparatus 102 receives the printed matter output from the image processing apparatus 101, and acquires image data for inspecting whether or not there is an abnormal image in the received printed matter. Here, the abnormal image degrades the quality of the printed matter. Examples thereof include an abnormal image (spot) having a round shape that occurs when a color material adheres to an unintended portion at the time of printing, color loss that occurs when a sufficient color material does not adhere to an intended portion, and a linear abnormal image (streak). Then, the acquired image data is transferred from the inspection apparatus 102 to the inspection PC 110 described later via the communication cable 130. The inspection PC 110 inspects whether or not there is an abnormal image in the printed matter, and the inspection apparatus 102 acquires an inspection result thereof from the inspection PC 110.

The finisher 103 receives the output sheet inspected by the inspection apparatus 102, switches the sheet discharge destination based on the inspection result of the inspection PC 110, and performs post-processing (binding or the like) as necessary. The printed matter having an abnormal image is discharged to a purge tray.

The image forming apparatus 100 is connected to the inspection PC 110 via the communication cable 130, and performs communication regarding image data at the time of inspection, an inspection result, and the like.

In the embodiment illustrated in FIG. 1, in the image forming apparatus 100, the image processing apparatus 101 and the inspection apparatus 102 will be described as individual apparatuses, but the present invention is not intended to be limited, and the image processing apparatus 101 and the inspection apparatus 102 may be integrated and provided as one apparatus. For example, the inspection apparatus 102 may be an apparatus constituting the image forming apparatus 100 integrally with the image processing apparatus 101. For example, the inspection PC 110 of the image forming apparatus 100 may be an apparatus integrated with the image forming apparatus 100 as an apparatus included in the inspection apparatus 102. In this case, a configuration such as an in-line inspection machine of the image forming apparatus 100 may be adopted that consistently performs image forming, inspection, post-processing, and sheet discharge.

Note that a detailed configuration of the image forming apparatus 100 in the present embodiment will be described later.

The inspection PC 110 is a PC for inspecting an image scanned from a printed matter using the inspection apparatus 102, and includes an apparatus control unit 111 and a user interface unit 118 (hereinafter, called “UI unit”). Furthermore, the apparatus control unit 111 includes a controller board, and a CPU 112, a RAM 113, a ROM 114, a communication I/F unit 115, a storage unit 116, and an inspection processing unit 117 are mounted on the apparatus control unit 111. These components are connected to one another via an internal system bus 119, and inter-module communication is performed. The inspection PC 110 may be configured to be built in the inspection apparatus 102.

The CPU 112 scans a main program from the storage unit 116 according to an initial program in the ROM 114, and stores the main program in the RAM 113. The RAM 113 is used as a main memory for storing programs and for working. The RAM 113 is used to temporarily store data created during processing of the program.

The communication I/F unit 115 is used when communicating with the image forming apparatus 100 or another apparatus via the network 120 or the communication cable 130. The storage unit 116 is used to store data such as a program, image data, and large-capacity data such as an inspection job.

In order to inspect whether or not there is an abnormal image such as contamination or color loss in image data acquired by the inspection apparatus 102, an inspection processing unit 117 acquires a difference value between a reference image stored in the RAM 113 as a correct image and the scanned image that is an inspection target. Next, the inspection processing unit 117 performs inspection by comparing, for each pixel, the acquired difference value with an inspection threshold (contrast and size) of each inspection item. Then, the inspection processing unit 117 stores an inspection result into the RAM 113. The inspection result is, for example, information on whether or not there is an abnormal image in the printed matter, position information of the abnormal image when the type (spot or streak) of the detected abnormal image is displayed on the UI unit 118, and the like. Then, the inspection PC 110 transmits the inspection result to the inspection apparatus 102 and the finisher 103 via the communication I/F unit 115 and the communication cable 130.

The UI unit 118 includes, for example, a keyboard, a mouse, a display, or another input/output apparatus, can input various setting values or designated values, and can display a display for settings and an inspection result.

The above is the description of the entire system configuration including the inspection apparatus 102 in an embodiment of the present invention. Note that in the present embodiment, each apparatus of the system performs communication regarding image data at the time of inspection, an inspection result, and the like via the communication cable 130, but any form may be adopted as long as the apparatuses can communicate with one another. Each apparatus may perform communication regarding image data at the time of inspection, an inspection result, and the like via the network 120, for example.

### Internal Configuration of Image Forming Apparatus 100

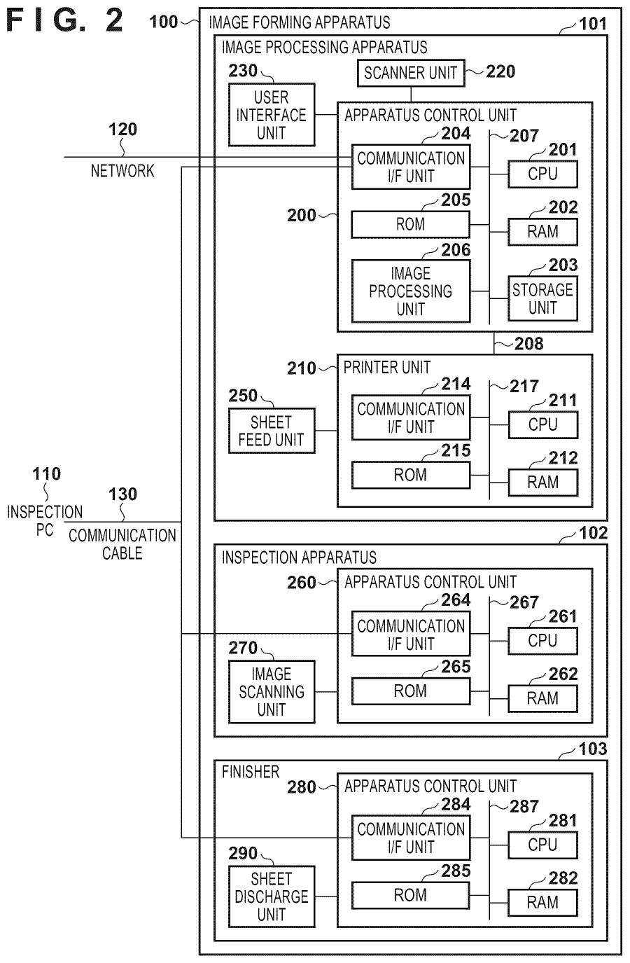

An internal configuration of the image forming apparatus 100 in the present embodiment will be described with reference to FIG. 2.

The image forming apparatus 100 includes the image processing apparatus 101, the inspection apparatus 102, and the finisher 103.

The image processing apparatus 101 further includes an apparatus control unit 200, a printer unit 210, a scanner unit 220, a user interface unit (UI unit) 230, and a sheet feed unit 250.

The apparatus control unit 200 receives an image or a document from the network 120 and converts the image or the document into print data. The apparatus control unit 200 includes a CPU 201, a RAM 202, a storage unit 203, a communication I/F unit 204, a ROM 205, and an image processing unit 206. The components can communicate with one another via an internal system bus 207. Note that since the roles of the components of the apparatus control unit 200 are similar to those of the inspection PC 110 except for the image processing unit 206, the description thereof will be omitted.

The image processing unit 206 performs image processing of acquiring page description language (PDL) data stored in the RAM 202 and converting the PDL data into print data. The image processing of converting into print data is, for example, as follows. First, raster image processor (RIP) processing is performed on the PDL data, thereby converting the PDL data into multivalued bitmap data. Then, known screen processing or the like is performed on the multivalued bitmap data, thereby converting the multivalued bitmap data into binary bitmap data. This binary bitmap data is print data. The binary bitmap data obtained by the image processing unit 206 is transmitted from the communication I/F unit 204 to the printer unit 210 via an internal system bus 208.

The printer unit 210 conveys a printing material (sheet) from the sheet feed unit 250, receives the binary bitmap data generated by the apparatus control unit 200, and forms an image on the printing material using a color material. At this time, the CPU 211 issues an instruction to the printer unit 210 based on the print settings designated by the user. For example, in a case of print settings using a coated sheet, the CPU 211 issues an instruction to the printer unit 210 so as to perform printing using a sheet feed deck storing the coated sheet in the sheet feed unit 250.

Various processing from reception of the PDL data described above to printing on the printing material are controlled by the apparatus control unit 200 and the printer unit 210, whereby a full-color toner image is formed on the printing material. The printer unit 210 includes the CPU 211, a RAM 212, a communication I/F unit 214, and a ROM 215. The components of the printer unit 210 can communicate with one another via an internal system bus 217. Note that since the roles of the components of the printer unit 210 are similar to the content described in the inspection PC 110, the description thereof will be omitted.

The scanner unit 220 is an apparatus for scanning a document image and obtaining the document image as image data. The scanner unit 220 irradiates a document image with a light source not illustrated, and obtains, as multivalued image data of red, green, and blue, a scanned signal obtained by scanning a document reflected image through a lens from a sensor such as a charge coupled device (CCD) sensor.

The UI unit 230 includes, for example, a keyboard, a mouse, a display, or another input/output apparatus, can input various setting values or designated values, and can display a display for settings and an inspection result. The sheet feed unit 250 includes one or more cassettes for setting a printing material to be printed. The sheet feed unit 250 feeds a printing material from a cassette corresponding to the size of the printing material designated in the print settings, and conveys the printing material to the printer unit 210.

The inspection apparatus 102 includes an apparatus control unit 260 and an image scanning unit 270.

The image scanning unit 270 is an image scanning unit that scans a printed matter conveyed from the printer unit 210.

The apparatus control unit 260 performs control for transferring the image data acquired by the image scanning unit 270 to the inspection PC 110 via the communication cable 130. Then, the inspection PC 110 inspects whether or not there is an abnormal image in the printed matter based on the transferred image data. The apparatus control unit 260 acquires an inspection result of the printed matter from the inspection PC 110. The apparatus control unit 260 includes a CPU 261, a RAM 262, a communication I/F unit 264, and a ROM 265. The components of the apparatus control unit 260 can communicate with one another via an internal system bus 267. Note that since the roles of the components of the apparatus control unit 260 are similar to those described in the inspection PC 110, the description thereof will be omitted.

The finisher 103 includes an apparatus control unit 280 and a sheet discharge unit 290.

The apparatus control unit 280 determines sheet discharge control performed by the sheet discharge unit 290 in consideration of the print settings and the inspection result. The apparatus control unit 280 includes a CPU 281, a RAM 282, a communication I/F unit 284, and a ROM 285. The components of the apparatus control unit 280 can communicate via an internal system bus 287. Note that since the roles of the apparatuses are similar to those of the apparatus control unit 200, the description thereof will be omitted.

The sheet discharge unit 290 is an apparatus for switching a sheet discharge destination of a printed matter conveyed from the inspection apparatus 102 based on post-processing (e.g., binding or the like) and an inspection result according to the print settings. For example, it is conceivable to switch the sheet discharge destination according to whether or not there is an abnormal image in the printed matter. When the sheet discharge destination is switched based on the inspection result, the finisher 103 uses the inspection result received from the inspection PC 110 to discharge a printed matter having no abnormal image to a normal sheet discharge tray, and discharge a printed matter having an abnormal image to a tray different from the normal sheet discharge tray.

### Hardware Configuration of Image Forming Apparatus 100

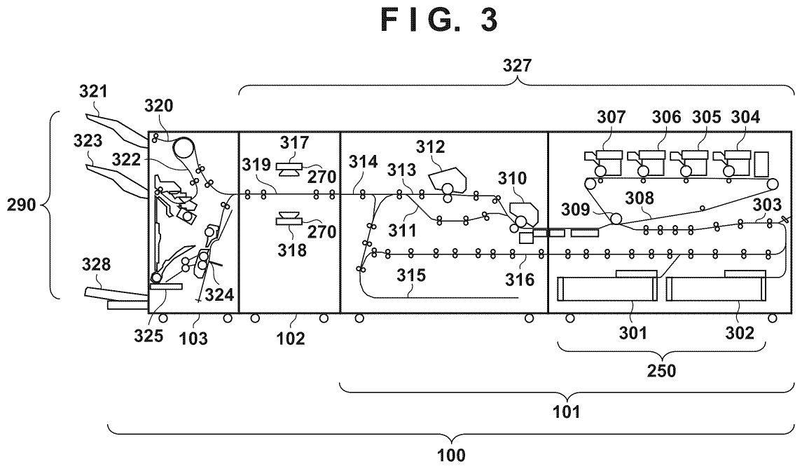

FIG. 3 is a cross-sectional view illustrating a hardware configuration example of the image forming apparatus 100. Hereinafter, a specific operation example of the image forming apparatus 100 will be described with reference to FIG. 3.

In the image processing apparatus 101, sheet feed decks 301 and 302 store various printing materials. Among the printing materials (sheets) stored in each sheet feed deck, the printing material positioned uppermost is separated one by one and fed to a conveyance path 303. Image forming stations 304 to 307, each including a photosensitive drum (photoreceptor), form toner images on the photosensitive drums using toner of different colors. Specifically, the image forming stations 304 to 307 form toner images using toner of yellow (Y), magenta (M), cyan (C), and black (K), respectively.

The toner images of the respective colors formed by the image forming stations 304 to 307 are sequentially superimposed, and transferred to an intermediate transfer belt 308 (primary transfer). The toner image transferred to the intermediate transfer belt 308 is conveyed to a secondary transfer position 309, by the rotation of the intermediate transfer belt 308. At the secondary transfer position 309, the toner image is transferred from the intermediate transfer belt 308 to the printing material conveyed through the conveyance path 303 (secondary transfer). The printing material after the secondary transfer is conveyed to a fixing unit 310. The fixing unit 310 includes a pressure roller and a heating roller. The fixing unit 310 performs fixing processing of applying heat and pressure to the printing material while the printing material passes through between these rollers and fixing the toner image onto the printing material. The printing material having passed through the fixing unit 310 is conveyed to a connection point 314 between the image processing apparatus 101 and the inspection apparatus 102 through a conveyance path 311. In this manner, a color image is formed (printed) on the printing material (sheet).

In a case where further fixing processing is required depending on the type of printing material, the printing material having passed through the fixing unit 310 is guided to a conveyance path 313 provided with a fixing unit 312. The fixing unit 312 performs further fixing processing on the printing material conveyed through the conveyance path 313. The printing material having passed through the fixing unit 312 is conveyed to the connection point 314. In a case where an operation mode for performing double-sided printing is set, an image is printed on a first surface, and the printing material conveyed through the conveyance path 311 or the conveyance path 313 is guided to a reverse path 315. The printing material reversed at the reverse path 315 is guided to a double-sided conveyance path 316 and conveyed to the secondary transfer position 309. By this, the toner image is transferred to a second surface on the side opposite to the first surface of the printing material at the secondary transfer position 309. Thereafter, the printing material passes through the fixing unit 310 (and the fixing unit 312), whereby the formation of the color image onto the second surface of the printing material is completed.

The image forming (printing) at the image processing apparatus 101 is completed, and the printed matter conveyed to the connection point 314 is conveyed into the inspection apparatus 102.

The inspection apparatus 102 includes image scanning units 317 and 318 each having a contact image sensor (CIS) on a conveyance path 319 through which the printed matter from the image processing apparatus 101 is conveyed. The image scanning units 317 and 318 are disposed at positions facing each other via the conveyance path 319. The image scanning units 317 and 318 are configured to scan the upper surface (first surface) and the lower surface (second surface) of the printed matter, respectively. Note that the image scanning units 317 and 318 may include, for example, a charge coupled device (CCD) or a line scan camera in place of the CIS.

The inspection apparatus 102 performs scanning processing of scanning the printed matter conveyed through the conveyance path 319 using the image scanning units 317 and 318. The printed matter having passed through the inspection apparatus 102 is sequentially conveyed to the finisher 103.

The finisher 103 executes a finishing function designated by the user on the printed matter conveyed from the inspection apparatus 102. In the present embodiment, the finisher 103 has, for example, a function of switching a sheet discharge destination based on an inspection result, and a finishing function such as a binding function. In a case of switching the sheet discharge destination based on the inspection result, the finisher 103 uses the inspection result received from the inspection PC 110 to discharge the printed matter having no abnormal image to a sheet discharge tray 321 via a sheet conveyance path 320. The finisher 103 discharges the printed matter having an abnormal image to a sheet discharge tray 323 (purge tray) via a sheet conveyance path 322. When binding is designated, the finisher 103 performs stapling processing on the center of the sheet of the printed matter by a processing unit 324, then folds the sheet in two, and outputs the sheet to a binding tray 326 via a sheet conveyance path 325.

A conveyance path 327 is configured to include the conveyance paths 303, 311, and 313 in the image processing apparatus 101 and the conveyance path 319 in the inspection apparatus 102.

The above is the description of the operation of the image forming apparatus 100 in an embodiment of the present invention. Not limited to the present embodiment, any configuration may be adopted as long as the configuration can print the print data onto a printing material (sheet) and scan an image for inspecting whether or not there is an abnormal image in a printed matter.

### Overall Inspection Flow

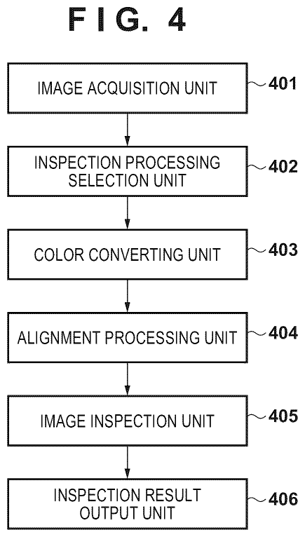

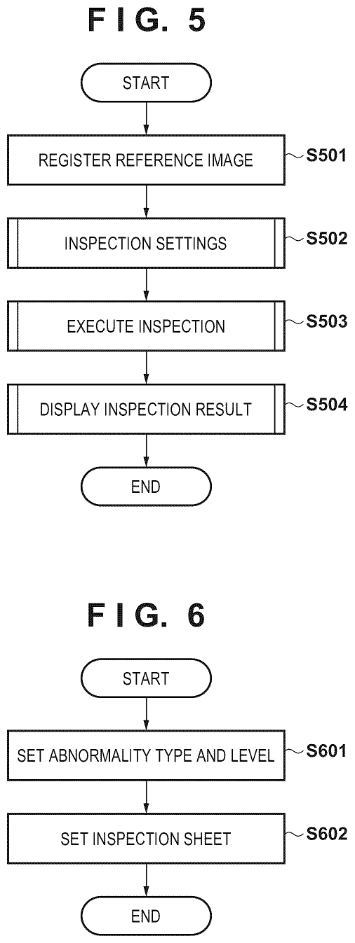

Next, the overall flow from registration work before start of inspection to execution of the inspection in the inspection PC 110 will be described with reference to FIG. 4 and FIG. 5. The processing described below is implemented by, for example, the CPU 112 of the inspection PC 110 reading, into the RAM 113, a program stored in the ROM 114 and executing the program. FIG. 4 is a block diagram illustrating a functional configuration of the inspection PC 110. FIG. 5 is a flowchart showing a processing procedure of inspection processing. In the following, the step number of each process in the flowchart is indicated by a number following “S”. The same applies to the subsequent flowcharts.

In S501, an image acquisition unit 401 registers an image to be a reference image for inspection. The image acquisition unit 401 acquires the reference image (reference image data) from the RAM 113 or the storage unit 116. However, the reference image data is assumed to be stored in the RAM 113 or the storage unit 116 in advance. Here, there are two creation methods of the reference image. The first one is a method of generating a correct image by executing a print job and scanning a printed matter by the image scanning unit 270. The other method is a method not using a scanned image but using, as a correct image, image data after RIP processing of analyzing the print job and generating the image data.

Next, in S502, according to the inspection settings by the user, an inspection processing selection unit 402 performs settings of various inspection parameters such as an inspection level and whether it is an inspection for a pre-printed sheet. Note that details of S502 in the present embodiment will be described later.

Next, in S503, the image acquisition unit 401 acquires an inspection target image by causing the image scanning unit 270 to scan the printed matter conveyed from the printer unit 210. Note that the inspection target image may be configured to be scanned in advance by the image scanning unit 270, and scan data held in the storage unit 116 or the RAM 113 is acquired. Then, an alignment processing unit 404 and an image inspection unit 405 perform alignment of the inspection target image and the reference image, and execute abnormality detection processing. Note that details of S503 in the present embodiment will be described later.

In S504, an inspection result output unit 406 generates a display screen of the inspection result, displays the display screen on the UI unit 118, and ends the process.

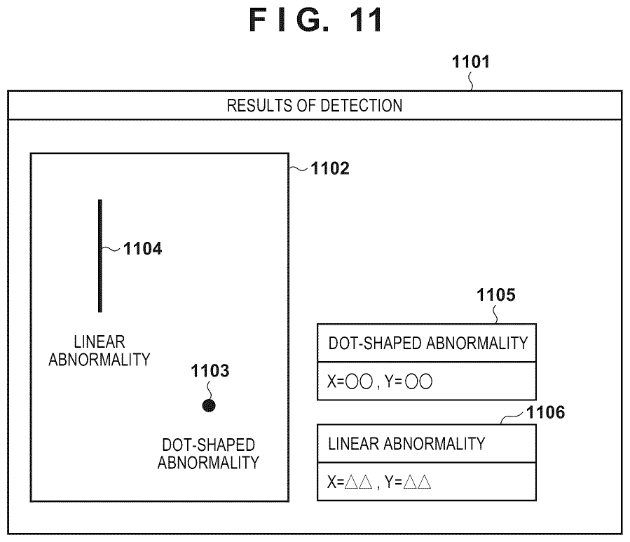

FIG. 11 illustrates an example of an inspection result display screen in the present embodiment. An inspection result display screen 1101 displays an entire image 1102 of the inspection target image. An abnormality 1103 is determined to be a dot-shaped abnormality, and characters “dot-shaped abnormality” are displayed together in the vicinity of the abnormality 1103. An abnormality 1104 is determined to be a linear abnormality, and characters “linear abnormality” are displayed together in the vicinity of the abnormality 1104. Furthermore, as illustrated in 1105 and 1106, the coordinates of each detected abnormality may be displayed together.

The above is the description regarding the overall flow from registration work before start of inspection to execution of the inspection by the inspection PC 110 in the present embodiment.

### Inspection Setting Processing

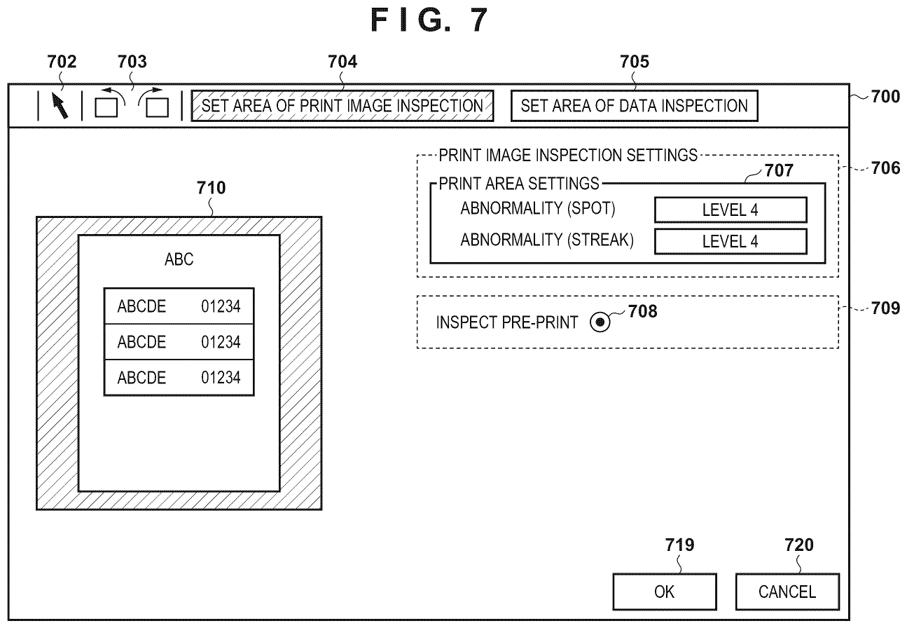

Next, a processing procedure of the inspection settings in S502 according to the present embodiment will be described with reference to FIGS. 6 and 7. FIG. 6 is a flowchart showing the processing procedure of inspection settings. FIG. 7 is a view illustrating an example of an inspection setting screen for setting inspection settings.

An inspection setting screen 700 includes buttons 702 to 705, a print image inspection setting UI 706, a pre-printed sheet setting UI 709, a page view area 710, an OK button 719, and a cancel button 720. The print image inspection setting UI 706 includes an inspection area setting 707 for setting a detection item and a detection level. The page view area 710 is an area for displaying a correct image.

In S601, the inspection processing selection unit 402 sets a detection item for detecting an abnormality and a detection level thereof. When the user operates an area setting button 704 of the print image inspection, the area of an inspection target and image inspection can be set. Although not illustrated, an area for print image inspection can be designated in the page view area of the correct image. Then, for the designated area, the detection item of the print image inspection can be set by the inspection area setting 707 in the print image inspection setting UI 706. The detection item of the print image inspection is an item regarding the feature of the abnormality desired to be detected when inspecting the printed matter, and is, for example, a dot-shaped abnormality (spot) or a linear abnormality (streak). The detection level is a parameter that is set for each stage from which magnitude the abnormality is determined for each feature of the detected abnormality. For example, there are five stages from level 1 to level 5, and an abnormality thinner and smaller in size can be detected in level 5 than level 1. A level can be set for each inspection item, such as a spot for the inspection level 5 and a streak for the inspection level 4. In the print image inspection setting UI 706 of FIG. 7, the inspection level setting of the abnormality (spot) indicates that level 4 is selected by the user, and the inspection level setting of the abnormality (streak) indicates that level 4 is selected by the user. The detection items can be set for each designated inspection area.

In S602, the user performs setting of the inspection sheet by the pre-printed sheet setting UI 709. The setting of the inspection sheet is a setting of whether or not the inspection sheet is a pre-printed sheet on which an image is printed in advance. When the sheet of the inspection target is a pre-printed sheet, the user can set that the inspection sheet is a pre-printed sheet by selecting a radio button 708.

When the user operates the OK button 719 after setting the print image inspection and setting the pre-printed sheet, the inspection processing selection unit 402 is notified of the setting of the print image inspection and the setting of the pre-printed sheet.

The above is the description regarding the processing procedure of the inspection setting in the present embodiment.

### Inspection Execution Processing

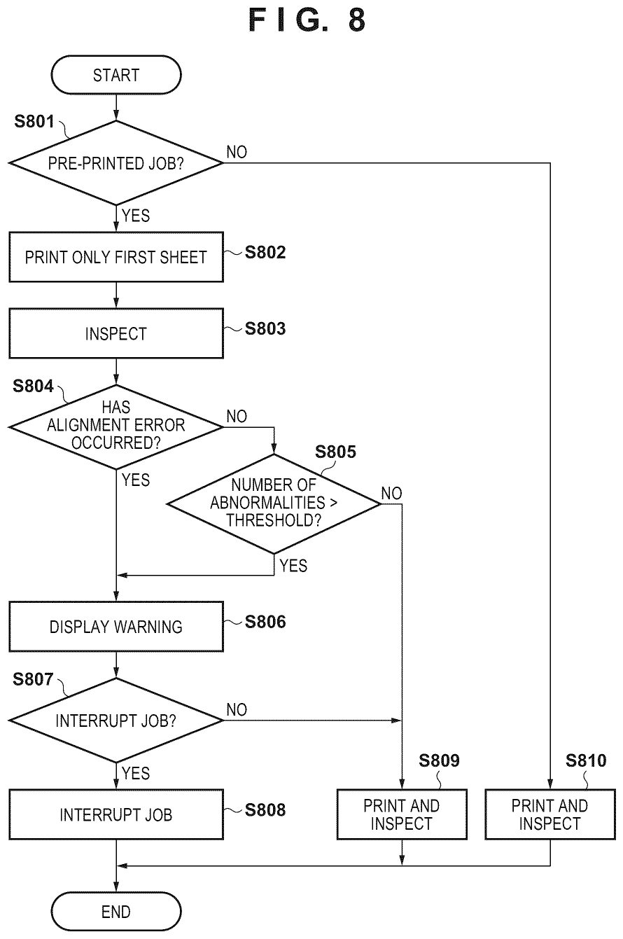

Next, a processing procedure of inspection execution in S503 according to the present embodiment will be described with reference to FIG. 8. FIG. 8 is a flowchart showing the processing procedure of the inspection execution processing in S503.

First, in S801, the inspection PC 110 determines whether it is inspection on a pre-printed sheet. Whether it is inspection on a pre-printed sheet is determined by whether the radio button 708 is selected, which is inspection on the pre-printed sheet, in S402. If the present inspection is determined to be inspection on a pre-printed sheet, the process proceeds to S802, and the inspection PC 110 instructs the image processing apparatus 101 to print only the first sheet of the job, and performs the inspection. The inspection PC 110 causes the image processing apparatus 101 to stand by printing of the second and subsequent sheets. If it is determined not to be inspection on a pre-printed sheet, the process proceeds to S810 to start printing and inspection of all sheets in the job.

In S802, the image processing apparatus 101 receives a notification from the inspection PC 110, and executes printing of the image of the first sheet.

In S803, the inspection apparatus 102 detects conveyance of the printed matter, scans the printed matter by the image scanning unit 270, and stores the scanned image into the RAM 113. Then, the inspection PC 110 compares the image in which the printed matter is scanned with the reference image serving as the correct image of the inspection saved in advance in the RAM 113, and acquires a difference value thereof. Inspection as to whether a printing abnormality exists in the scanned image is performed based on the acquired difference value.

In S804, the inspection PC 110 determines whether an alignment error has occurred during inspection.

### Alignment Error Determination Method

An alignment error determination method will be described. The alignment processing unit 404 acquires a feature point in order to perform alignment of the reference image and the inspection image. As an acquisition method of the feature point, a pixel having a large corner feature amount in the image is conceivable. Various techniques have been devised for detection of corner feature amounts. One of methods of detecting the corner feature amounts is a known technique called Harris corner detection method. In Harris corner detection method, a corner feature amount image is detected from a differential image in a main scanning direction and a differential image in a sub-scanning direction. While in the corner feature, both of two edges should be strong edges, the magnitude of the corner feature amount is expressed by whether even a relatively weak edge has a strong edge amount.

Then, the alignment processing unit 404 adopts, as a feature point, a pixel having a feature amount larger than a predetermined value.

When the pixel values at the respective positions of the reference image and the inspection image after alignment are compared with each other, if the difference between the pixel values is too large, an alignment error has occurred. Then, when the difference value between the pixel values of the pixels of the feature points of the reference image and the inspection image after the alignment is larger than a preset threshold, the alignment processing unit 404 does not accurately perform the alignment, and the inspection PC 110 determines that an alignment error occurs.

In another example, a method of determination may be adopted, the determination being made based on whether the total amount of difference amounts between the pixel values of the inspection image and the reference image after the alignment is larger than a predetermined threshold.

As another method, a method of determination may be adopted, the determination being made based on whether the difference amount between the coordinate positions of the four corners of the sheet of the inspection image after the alignment and the coordinate positions of the four corners of the sheet of the reference image is equal to or greater than a threshold.

Upon determining that an alignment error occurred during the inspection in S804, the inspection PC 110 advances the process to S806. Upon determining that an alignment error did not occur during the inspection, the inspection PC 110 advances the process to S805.

In S805, by comparing the number of detected abnormalities with a predetermined threshold, the inspection PC 110 determines mismatch between the pre-printed sheet and the print direction. If the orientation of the pre-printed sheet and the orientation of printing do not match, the inspection PC 110 can determine mismatch in the print direction due to an extremely large number of abnormalities. If the number of abnormalities is larger than the threshold, the inspection PC 110 determines that the orientation of the pre-printed sheet and the orientation of printing do not match, and advances the process to S806. When the number of abnormalities is equal to or less than the threshold, the inspection PC 110 determines that the cause of the abnormalities is contamination or the like, advances the process to S809, and starts printing and inspection of the second and subsequent sheets caused to stand by.

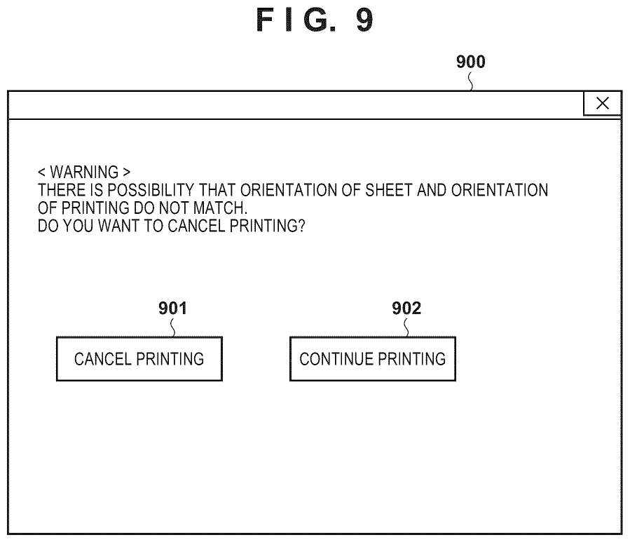

In S806, the inspection PC 110 displays a warning display 900 illustrated in FIG. 9, for example, onto the UI unit 118 and notifies the user that there is a possibility that the orientation of the pre-printed sheet and the orientation of printing do not match. The warning display 900 is a UI for displaying that there is a possibility that the orientation of the pre-printed sheet and the orientation of printing do not match, and for causing the user to confirm whether to continue the job as it is or to stop the job. A cancel button 901 is a button for the user to cancel the job. A continuation button 902 is a button for the user to continue the job. The apparatus control unit 111 continues the display of the warning display 900 until either the cancel button 901 or the continuation button 902 is operated according to the user operation. The cancel button 901 and the continuation button 902 are examples of display objects.

In S807, the inspection PC 110 determines whether either the cancel button 901 or the continuation button 902 is selected according to the user operation, and if the cancel button 901 is selected, advances the process to S808 (in the case of Yes). If the continuation button 902 is selected, the inspection PC 110 advances the process to S809 (in the case of No), and starts processing of printing and inspection of the second and subsequent sheets caused to stand by.

In S808, the inspection PC 110 notifies the image processing apparatus 101 of cancellation of the job, and ends the printing and inspection execution processing.

In step S809, the inspection PC 110 notifies the image processing apparatus 101 of permission of printing of the second and subsequent sheets that the image processing apparatus 101 has been caused to stand by, causes the image processing apparatus 101 and the inspection apparatus 102 to execute printing and inspection of all the sheets, and ends the inspection execution processing.

In step S810, the inspection PC 110 notifies the image processing apparatus 101 of permission of printing of all the sheets in the job, executes printing and inspection of all the sheets, and ends the printing and the inspection execution processing.

### Description of Effects

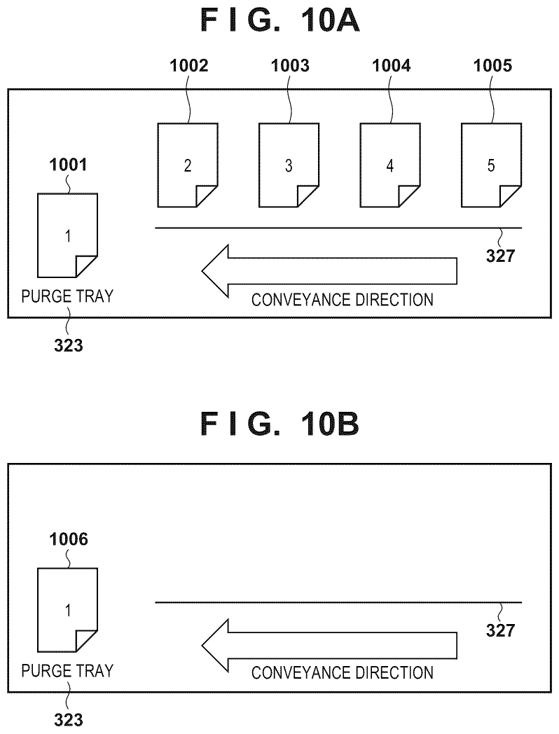

Effects of the present invention will be described with reference to FIGS. 10A and 10B. Here, in FIGS. 10A and 10B, a case where single-sided printing is performed is given as an example, but the process is similar even in a case of using double-sided printing.

FIG. 10A illustrates a state of a printed matter in a case where the orientation of the pre-printed sheet and the orientation of printing are wrong in a known technique. A printed matter 1001 is determined as an error and discharged to the purge tray 323. At the time point when the printed matter 1001 is determined as an error, printed matters 1002 to 1005 have already been conveyed on the conveyance path 327. After the error of the printed matter 1001 is detected, the printing is temporarily stopped. In a case where the orientation of setting of the pre-printed sheet and the orientation of the printing are wrong, the printed matters 1002 to 1005 also have an error, and not only the first sheet but also the in-machine residual sheets also become waste paper.

FIG. 10B illustrates a state of the printed matter in a case where the orientation of setting of the pre-printed sheet and the orientation of printing are wrong in the present embodiment. A printed matter 1006 is determined as an error and discharged to the purge tray 323. In the present embodiment, when the inspection of the first sheet is not normally ended, printing of the second and subsequent sheets is not executed, and thus the subsequent printed matters are not conveyed onto the conveyance path 327.

When the orientation of setting of the pre-printed sheet and the orientation of printing are wrong, five sheets of waste paper are generated in the case of using the known technique, but only one sheet of waste paper is generated in the case of using the present invention, and the waste paper can be reduced.

### Effects of Present Embodiment

According to the present invention, it is possible to reduce waste paper generated when a pre-printed sheet is set in an incorrect orientation without impairing user convenience.

### SECOND EMBODIMENT

Together with the print image inspection, in the inspection of a print image using a pre-printed sheet, a variable area part such as a character string or a barcode is inspected in variable printing. Variable printing refers to printing in which content to be printed out onto the sheet can be changed based on data. In variable printing, different character strings, barcodes, and the like are printed on a pre-printed sheet one by one based on data. Examples of the inspection of the variable area part include, for example, data scannable inspection for checking whether a character string or a barcode is scannable, and a data collation inspection for collating a scanning result of a character string or a barcode with “correct-data”. The data scannable inspection and the data collation inspection are called data inspection. Note that the correct-data is prepared in advance, for example, prepared by designating a CSV file or the like.

In the first embodiment, the case where the orientation of set of a pre- printed sheet and the orientation of printing are wrong has been described. In the second embodiment, a case where correct-data for comparison is wrongly designated at the time of data inspection will be described. In the present embodiment, it is possible to reduce waste paper in a case where incorrect data for comparison is designated.

Hereinafter, only differences from the first embodiment will be described in detail.

### Outline of Data Inspection

An outline of the data inspection performed by the inspection PC 110 will be described.

The inspection PC 110 scans the printed matter conveyed from the image forming apparatus 100 by the image scanning unit 270 and acquires a scanned image of the inspection target. The acquired scanned image of the inspection target is saved in the RAM 113 or the storage unit 116. Subsequently, the inspection PC 110 causes the inspection processing unit 117 to inspect whether a character string or a barcode is scannable using font information for character recognition (OCR) set in advance or a barcode standard. It is also possible to perform data inspection of collating whether the scanned character string or the result of the barcode match the correct-data. The inspection PC 110 saves the inspection result into the RAM 113. Examples of the inspection result include, for example, a result of a character string or a barcode scanned from a printed matter, a result of collation with correct-data, and position information of a scanned character or barcode when displayed on the UI unit 118. Note that the correct-data is saved in advance in the RAM 113 or the storage unit 116 of the inspection PC 110.

### Regarding Inspection Setting UI

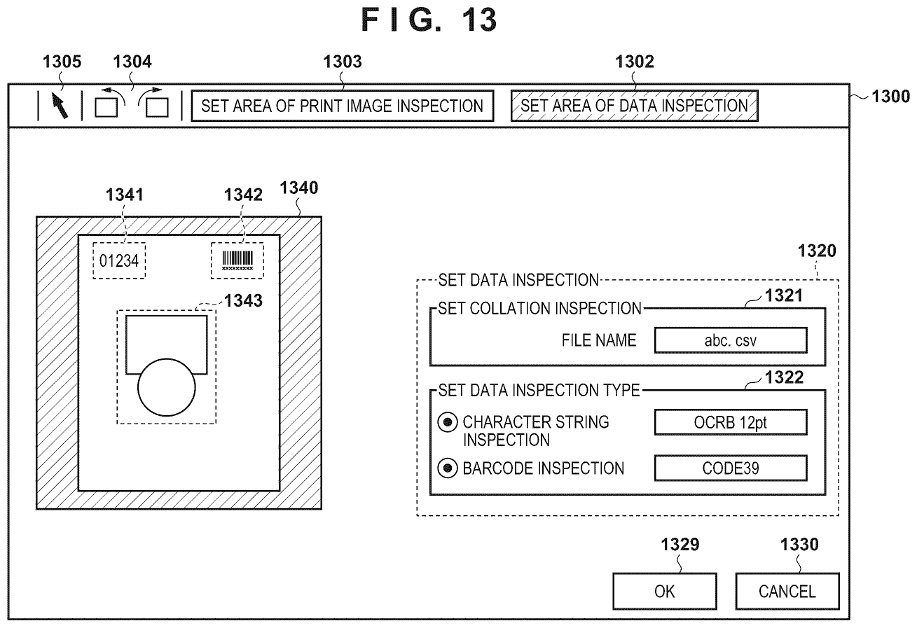

Next, an example of a UI regarding inspection settings will be described with reference to FIG. 13.

A data inspection setting screen 1300 of FIG. 13 is a screen to be displayed in the inspection setting of S502 and corresponds to the setting screen 700 of FIG. 7. In FIG. 7, an area setting button 704 of print image inspection is selected, but in FIG. 13, when an area setting button 1302 of data inspection is operated, the data inspection setting screen 1300 is displayed.

A page preview 1340 is a display area for displaying a correct image.

A method of setting a data inspection area in the present embodiment is the following procedure. First, the area setting button 1302 of data inspection is selected by the user operation. Then, when the area where the data inspection is performed in the page preview 1340 is designated by the user operation, the inspection PC 110 sets a corresponding designated range as data inspection area 1341 and data inspection area 1342. Note that the data inspection area is an inspection area for scanning a type of data (character string or barcode) that is set and making a correct/incorrect determination.

A button 1304 is a button for rotating the image displayed on the page preview 1340. A button 1305 is a selection button of the inspection area, and is a button operated by the user when the setting information of the area that is already set is desired to be changed.

A data inspection setting UI 1320 is a group of UIs for setting a data file to be referred to at the time of collation with the detected data, a type of data inspection, and detailed information thereof when the data inspection is performed. Note that the data inspection area is an inspection area for scanning a type of data (character string or barcode) that is set and making a correct/incorrect determination.

A data UI 1321 of collation inspection is a UI that sets, by a file selection method, a file of variable data used as correct character information for correct/incorrect determination in the data inspection.

The variable data in the present embodiment is a reference CSV file for data inspection to be collated as a correct answer when data inspection is performed. The reference CSV file is a file in which correct character strings of character string inspection and barcode inspection are listed with comma separators. The reference CSV file is also used as data to be input to the variable area when document data to be variably printed is generated. Since the document data is generated with reference to the reference CSV file, the arrangement order of the document data and the data of the reference CSV file match. Therefore, it is possible to make a correct/incorrect determination of data by collating the scanned results of the character string inspection area and the barcode with the correct character string listed in the reference CSV file at the time of executing the data inspection.

In a case where the printing order of the document data is changed, the arrangement order of the data of the CSV file being referred to does not match, and thus the document data no longer matches the correct character string listed in the reference CSV file. Here, the data UI 1321 of the collation inspection of FIG. 13 indicates that data having a file name of abc.csv is selected as the data of the collation inspection. It is assumed that the CSV file is saved in the storage unit 116 or the RAM 113 in advance.

Next, a data inspection type setting UI 1322 is a UI for setting the type of the character string inspection or the barcode inspection selected by the user with a radio button method and a pull-down method.

The type of character string in the present embodiment is a set of font data in which a character shape image of a character and a character code are associated for character recognition (OCR). Note that it is necessary to save a set of font data in advance. The user can perform registration processing of printing the character shape image of the character and associating the character shape image with the character code, and a corresponding font data set can be saved in advance in a shipment state. In the data inspection type setting UI 1322 of FIG. 13, both the character string inspection and the barcode inspection are selected with the radio button. The example of FIG. 13 illustrates that OCRB 12 pt is selected as the character shape font for character string inspection, and CODE39 is selected as the barcode standard for barcode inspection.

### Inspection Execution Processing

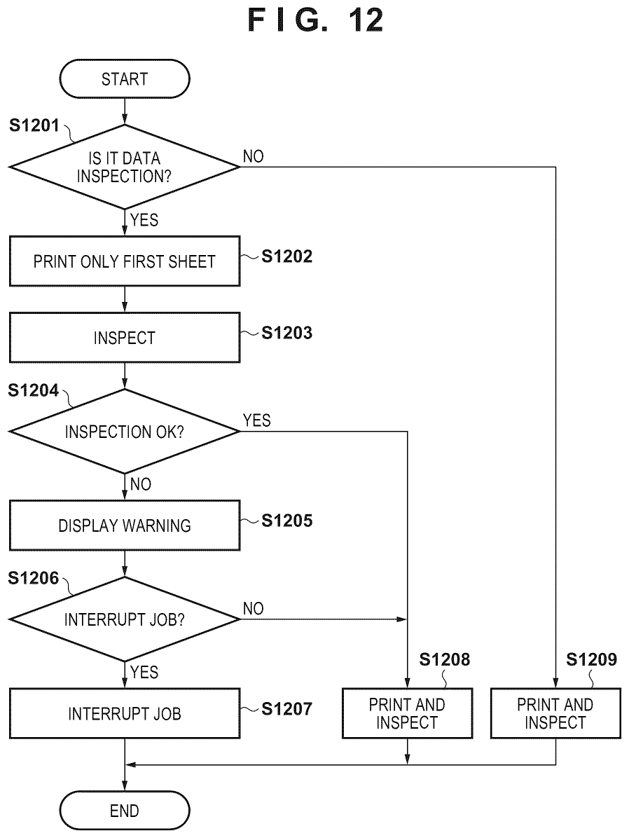

Next, the processing procedure of inspection execution of S503 according to the present embodiment will be described with reference to FIG. 12. FIG. 12 is a flowchart showing the processing procedure of the inspection execution processing in S503.

First, in S1201, the inspection PC 110 determines whether it is data inspection from the inspection settings. Whether it is data inspection is determined by whether the settings of inspection have been performed in the data inspection area setting UI 1340 or the data inspection setting UI 1320. Upon determining that the present inspection is the data inspection, the inspection PC 110 advances the process to S1202 (in the case of YES), and controls the image processing apparatus 101 and the inspection apparatus 102 so as to perform printing and inspection of only the first sheet of the job. Upon determining that the present inspection is not the data inspection, the inspection PC 110 advances the process to S1209 to start printing and inspection of all the sheets in the job (in the case of NO).

In S1202, the image processing apparatus 101 receives the notification from the apparatus control unit 111 of the inspection PC 110, and executes printing of the image of the first sheet.

In S1203, the inspection apparatus 102 extracts the data inspection area from the inspection image, decodes the extracted data inspection area into a character string according to the inspection settings, performs the collation inspection of the scanned character string and the correct-data, and advanced the process to S1204.

In S1204, the inspection PC 110 determines whether the inspection result is correct (OK) or an error (Not OK) has occurred during the data inspection. When the scanning result of the character string or the barcode and the correct-data do not match, it is determined to be data inspection error (Not OK), and the process proceeds to S1205 (in the case of NO). In the case of matching (in the case of OK), the process proceeds to S1208 (in the case of YES), and the image processing apparatus 101 and the inspection apparatus 102 are controlled so as to execute printing and inspection of the subsequent sheet having been caused to stand by.

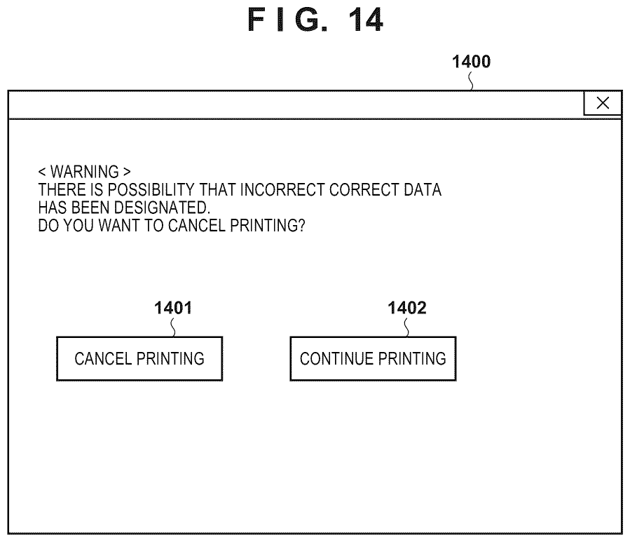

In S1205, the inspection PC 110 displays, on the UI unit 118, a warning display screen illustrated in FIG. 14, for example, and notifies the user that there is a possibility that incorrect correct-data is designated in the data UI 1321 of the collation inspection. A warning display screen 1400 is a UI for displaying that there is a possibility that incorrect correct-data has been designated and confirming whether to continue the job as it is or to cancel the job. A cancel button 1401 is a button for the user to cancel the job. A continuation button 1402 is a button for the user to continue the job. The apparatus control unit 111 continues display of the warning display screen 1400 until either the cancel button 1401 or the continuation button 1402 is selected according to the user operation. The cancel button 1401 and the continuation button 1402 are examples of display objects.

In S1206, the inspection PC 110 determines whether either the cancel button 1401 or the continuation button 1402 is selected according to the user operation, and if the cancel button 1401 is selected, advances the process to S1207 (in the case of YES). If the continuation button 1402 is selected, the inspection PC 110 advances the process to S1208, and controls the image processing apparatus 101 and the inspection apparatus 102 so as to execute printing and inspection of the second and subsequent sheets caused to stand by (in the case of NO).

In S1207, the inspection PC 110 notifies the image processing apparatus 101 of interruption of the job, and ends the printing and inspection execution processing.

In S1208, the inspection PC 110 notifies the image processing apparatus 101 of permission of printing of the second and subsequent sheets having been caused to stand by, executes printing and inspection of all the sheets, and ends the inspection execution processing.

In S1209, the inspection PC 110 notifies the image processing apparatus 101 of permission of printing of all the sheets in the job, executes printing and inspection of all the sheets, and ends the inspection execution processing.

### Effects of Present Embodiment

According to the present embodiment, in a case where correct-data for comparison is wrongly designated in the data inspection, the printing and inspection of the second and subsequent sheets are caused to stand by until the inspection of the first sheet is normally completed, whereby waste paper can be reduced.

In a case where correct-data for comparison is wrongly designated in the data collation inspection by the known technique, printing of the second and subsequent sheets is also started before the inspection of the first sheet is started, and all the print sheets become waste paper.

### THIRD EMBODIMENT

In the second embodiment, the case where correct-data for comparison is wrongly designated at the time of data inspection has been described. In the third embodiment, a case where an incorrect image is set as a reference image will be described.

In the present embodiment, it is possible to reduce waste paper when an incorrect reference image is designated.

Hereinafter, only differences from the first embodiment will be described in detail.

### Inspection Execution Processing

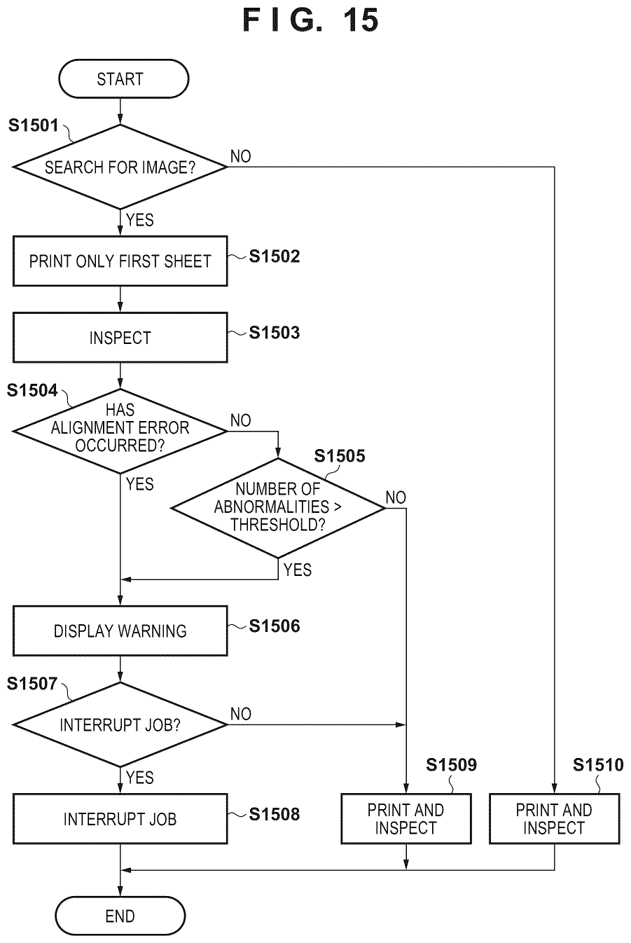

The processing procedure of inspection execution of S503 according to the present embodiment will be described with reference to FIG. 15. FIG. 15 is a flowchart showing the processing procedure of the inspection execution processing in S503.

First, in S1501, the inspection PC 110 determines whether it is print image inspection. Whether it is print image inspection is determined by whether the inspection level is set by the print image inspection setting UI 706. Upon determining that it is print image inspection, the inspection PC 110 advances the process to S1502 (in the case of YES), and controls the image processing apparatus 101 and the inspection apparatus 102 so as to print only the first sheet of the job and perform the inspection. Upon determining that it is not the inspection for the print image inspection, the inspection PC 110 advances the process to S1510 to start printing and inspection of all the sheets in the job (in the case of NO).

In S1502, the image processing apparatus 101 receives a notification from the inspection PC 110, and executes printing of the image of the first sheet.

In S1503, the inspection apparatus 102 detects conveyance of the printed matter, scans the printed matter by the image scanning unit 270, and transmits the scanned image to the inspection PC 110. The inspection PC 110 stores, into the RAM 113, the transmitted scanned image of the printed matter. Then, the inspection PC 110 compares the scanned image in which the printed matter is scanned with the reference image serving as the correct image of the inspection saved in advance in the RAM 113, and acquires a difference value thereof. Inspection as to whether a printing abnormality exists in the scanned image is performed based on the acquired difference value.

In S1504, the inspection PC 110 determines whether an alignment error has occurred during inspection. When an incorrect reference image is selected, a corresponding point to be aligned is not found, and a parameter for alignment (e.g., affine matrix) may have an extremely large value or an extremely small value. By comparing each element of the affine matrix with a predetermined threshold, it is possible to determine an alignment error.

Upon determining that an alignment error occurred during the inspection in S1504, the inspection PC 110 advances the process to S1506 (in the case of YES). Upon determining that an alignment error did not occur during the inspection, the inspection PC 110 advances the process to S1505 (in the case of NO).

In S1505, by comparing the number of detected abnormalities with a predetermined threshold, the inspection PC 110 determines whether an incorrect reference image has been set. When the reference image and the inspection image are different from each other, the number of abnormalities becomes extremely large, whereby it can be determined that an incorrect reference image has been set. If the number of abnormalities is larger than the threshold, the inspection PC 110 determines that an incorrect reference image has been set, and advances the process to S1506 (in the case of YES). When the number of abnormalities is equal to or less than the threshold, the inspection PC 110 determines that the cause of the abnormalities is contamination or the like, advances the process to S1509 (in the case of NO), and controls the image processing apparatus 101 and the inspection apparatus 102 so as to start printing and inspection of the second and subsequent sheets caused to stand by.

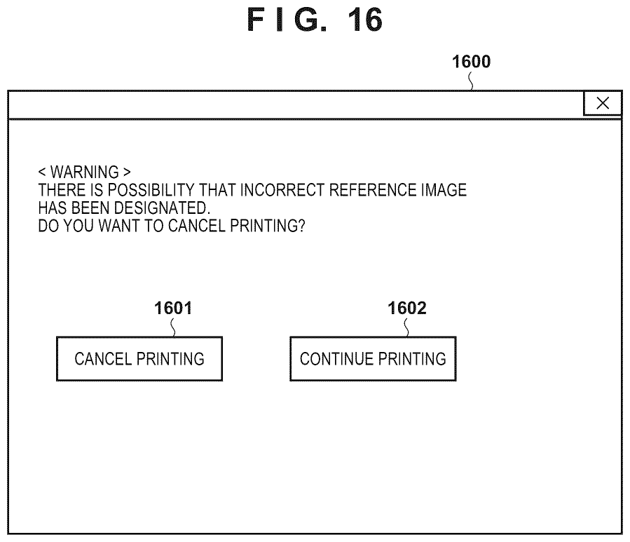

In S1506, the inspection PC 110 displays, on the UI unit 118, a warning display 1600 illustrated in FIG. 16, for example, and notifies the user that there is a possibility that an incorrect reference image has been designated. The warning display 1600 is a UI for displaying that there is a possibility that an incorrect reference image has been designated, and for the user to confirm whether to continue the job as it is or to stop the job. A cancel button 1601 is a button for the user to cancel the job. A continuation button 1602 is a button for the user to continue the job. The apparatus control unit 111 continues display of the warning display screen 1600 until either the cancel button 1601 or the continuation button 1602 is selected according to the user operation. The cancel button 1601 and the continuation button 1602 are examples of display objects.

Since the subsequent processing is similar to that of the first embodiment, description thereof is omitted.

### Effects of Present Embodiment

According to the present embodiment, in a case where an incorrect image is set as a reference image, the printing and inspection of the second and subsequent sheets are caused to stand by until the inspection of the first sheet is normally completed, whereby waste paper can be reduced.

In a case where an incorrect image is designated as a reference image in the known technique, printing of the second and subsequent sheets is also started before the inspection of the first sheet is started, and all the print sheets become waste paper.

### OTHER EMBODIMENTS

Embodiment(s) of the present invention can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2024-059139, filed Apr. 1, 2024, which is hereby incorporated by reference herein in its entirety.

What is claimed is:

1. An inspection apparatus comprising:
an inspection unit configured to inspect a scanned image in which a scanning unit scans a sheet on which an image is formed, the sheet being conveyed from an image processing apparatus; and
a control unit configured to perform control to cause image forming of a second and subsequent sheets to stand by until image forming of a first sheet and inspection according to inspection settings are completed in a job of performing image forming on a plurality of sheets.

2. The inspection apparatus according to claim 1, wherein the inspection settings are settings of inspection of image forming on a pre-printed sheet.

3. The inspection apparatus according to claim 1, wherein the inspection settings are settings related to data included in the scanned image.

4. The inspection apparatus according to claim 1, wherein the inspection settings are settings of image inspection using a registered reference image.

5. The inspection apparatus according to claim 1, wherein the inspection unit displays a setting screen for setting the inspection settings.

6. The inspection apparatus according to claim 1, wherein the inspection unit determines an alignment error of a sheet.

7. The inspection apparatus according to claim 6, wherein the inspection unit determines the alignment error based on a difference in pixel values of corresponding pixels between a reference image and the scanned image.

8. The inspection apparatus according to claim 1, wherein the inspection unit detects whether a number of abnormalities that are detected is larger than a predetermined threshold.

9. The inspection apparatus according to claim 8, wherein when a number of abnormalities that are detected by the inspection unit is smaller than a predetermined threshold, the control unit starts image forming of the second and subsequent sheets caused to stand by.

10. The inspection apparatus according to claim 1, wherein the control unit performs control of displaying a warning display on a display unit when the inspection unit detects an abnormality of the scanned image.

11. The inspection apparatus according to claim 10, wherein the warning display includes a display object that can receive an instruction as to whether to stop or continue the image forming of the second and subsequent sheets caused to stand by.

12. The inspection apparatus according to claim 1, further comprising:
an image processing unit configured to form an image on a sheet; and
a scanning unit configured to scan the sheet on which the image is formed.

13. A method for controlling an inspection apparatus comprising:
inspecting a scanned image in which a scanning unit scans a sheet on which an image is formed, the sheet being conveyed from an image processing apparatus; and
performing control to cause image forming of a second and subsequent sheets to stand by until image forming of a first sheet and inspection according to inspection settings are completed in a job of performing image forming on a plurality of sheets.
